(19) United States
(12) Patent Application Publication
(10) Pub. No.: US 2017/0031580 A1
(43) Pub. Date: Feb. 2, 2017

(54) ELECTRONIC APPARATUS, NON-TRANSITORY COMPUTER-READABLE RECORDING MEDIUM, AND DISPLAY CONTROL METHOD OF ELECTRONIC APPARATUS

(71) Applicant: KYOCERA CORPORATION, Kyoto (JP)

(72) Inventor: Kana MASAKI, Yokohama-shi (JP)

(21) Appl. No.: 15/215,429

(22) Filed: Jul. 20, 2016

(30) Foreign Application Priority Data
Jul. 28, 2015 (JP) 2015-148815

(51) Int. Cl. G06F 3/0484; H04N 21/414; H04N 21/472; G06F 3/0482; G06F 3/0488

(52) U.S. Cl. CPC G06F 3/04847; G06F 3/0482; G06F 3/0488; H04N 21/47205; H04N 21/41407

(57) ABSTRACT

An electronic apparatus, a recording medium, and a display control method are disclosed. In one embodiment, an electronic apparatus comprises a display screen and at least one processor. The display screen can display a first object and a second object, and the processor causes display screen to display the first object and the second object. In a first state where the first object and the second object are displayed on the display screen, when a second operation of separating positions of the first object and second object from each other is detected after a first operation of selecting the first object and the second object is detected, the processor changes a display of the display screen to a second state where the first object and the second object, which are more distant from each other than those in the first state, are displayed with a third object displayed therebetween.

### CROSS-REFERENCE TO RELATED APPLICATION

The present application claims priority under 35 U.S.C. §119 to Japanese Patent Application No. 2015-148815, filed on Jul. 28, 2015, entitled “ELECTRONIC APPARATUS”. The content of which is incorporated by reference herein in its entirety.

### FIELD

Embodiments of the present disclosure relate to an electronic apparatus.

### BACKGROUND

Recently, electronic apparatuses such as a personal computer and a mobile terminal (a mobile phone, a tablet terminal, a mobile game machine, or the like) have a function to display an object such as, for example, a thumbnail, an icon, an application, and an image.

### SUMMARY

An electronic apparatus, a recording medium, and a display control method are disclosed. In one embodiment, an electronic apparatus comprises a display screen and at least one processor. The display screen can display a first object and a second object. The processor causes display screen to display the first object and the second object. In a first state where the first object and the second object are displayed on the display screen, when a second operation of separating positions of the first object and second object from each other is detected after a first operation of selecting the first object and the second object is detected, the processor changes a display of the display screen to a second state where the first object and the second object, which are more distant from each other than those in the first state, are displayed with a third object displayed therebetween.

In one embodiment, a non-transitory computer-readable recording medium stores a control program so as to cause an electronic apparatus including a display screen to perform the following step. In a first state where the first object and the second object are displayed on the display screen, when a second operation of separating positions of the first object and second object from each other is detected after a first operation of selecting a first object and a second object is detected, a display of the display screen is changed to a second state where the first object and the second object, which are more distant from each other than those in the first state, are displayed with a third object displayed therebetween.

In one embodiment, a display control method of an electronic apparatus including a display screen comprises the following step. In a first state where the first object and the second object are displayed on the display screen, when a second operation of separating positions of the first object and second object from each other is detected after a first operation of selecting a first object and a second object is detected, a display of the display screen is changed to a second state where the first object and the second object, which are more distant from each other than those in the first state, are displayed with a third object displayed therebetween.

### BRIEF DESCRIPTION OF THE DRAWINGS

FIG. 1 illustrates an external perspective view of a mobile phone 100 showing an embodiment of the disclosure.

FIG. 2 illustrates a block configuration diagram of the mobile phone 100.

FIG. 3 illustrates an example of a display screen 102 of the mobile phone 100.

FIGS. 4A to 4D illustrate a screen transition of the display screen 102 of the mobile phone 100.

FIGS. 5A to 5D illustrate screen transition diagrams of the display screen 102 after the screen transition in FIG. 4.

FIGS. 6A and 6B illustrate screen transition diagrams of the display screen 102 after the screen transition in FIG. 5.

FIGS. 7A and 7B illustrate screen transition diagrams of the display screen 102 of the mobile phone 100.

FIGS. 8A and 8B illustrate screen transition diagrams of the display screen 102 of the mobile phone 100.

FIG. 9 illustrates a part of flowchart of a program in the mobile phone 100.

FIG. 10 illustrates the display screen 102 of the mobile phone 100.

FIGS. 11A to 11D illustrate screen transition diagrams regarding a display screen 102 different from the display screen 102 shown in FIGS. 4A to 8B.

### DETAILED DESCRIPTION

An electronic apparatus according to one embodiment is described hereinafter.

Configuration

An electronic apparatus according to one embodiment is, for example, a personal computer, or a mobile terminal (a mobile phone, a tablet terminal, a mobile game machine, or a wearable device (a device in a form of a watch, glasses, a belt, or a cloth, for example, having a display screen)).

The mobile phone is described as a one example of the electronic apparatus, however, the electronic apparatus according to the present disclosure is not limited to the mobile phone.

The present disclosure is described using the mobile phone which is one example of the electronic apparatus.

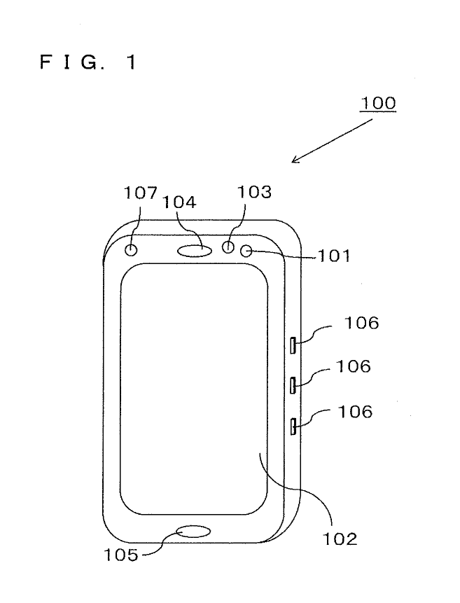

FIG. 1 illustrates an external perspective view of a mobile phone 100. Illustrated in FIG. 1 as one example is the straight type mobile phone 100 being operable with a touch operation.

As described above, illustrated is the straight type mobile phone 100 as one example of the mobile phone, however, the present disclosure may be also applied to another type of mobile phone such as a folding mobile phone and a slider mobile phone.

Provided in an outer side of the mobile phone 100 shown in FIG. 1 are a lamp 101, a display screen 102, an optical sensor 103, a speaker (receiver) 104, a microphone 105, a button part 106, and a camera window 107.

The lamp 101, by emitting light outside, can inform a user of an incoming-call information that, for example, the mobile phone 100 is getting a call and have a missed call or a received-mail information that, for example, the mobile phone 100 has received a new email and have a unread email. The lamp 101 can also inform the user of an arrival of an alarm date and time, for example. A light-emitting element such as LED constitutes the lamp 101. The lamp 101 is an LED lamp, for example. The lamp 101 lights or blinks the light to inform the user of the information.

The display screen 102 can display various information. The various information include displays of, for example, an icon indicative of an application, a running application, incoming signal strength, a remaining battery level, a date, and a time. The display screen 102 includes a transparent cover panel, and a display 120 provided in a back side of the cover panel. The display 120 is, for example, a liquid crystal display, an organic EL (Electro Luminescence) display, a plasma display, and an electronic paper. When the display 120 is made up of the liquid crystal display, a backlight of the display 120 emits the light to display the various information on the display screen 102. Meanwhile, when the display 120 is made up of the organic EL display, a light emitter of the display 120 emits the light to display the various information on the display screen 102.

One example of an operation part receiving an operation performed by the user includes a touch operation part 114. The touch operation part 114 includes a touch panel, for example. The touch panel includes various types of panels such as an electrostatic capacitance type, a resistance film type, an optical type, an ultrasonic surface acoustic wave type, an infrared light shielding type, an electromagnetic induction type, and an image recognition type. The operation part may also be a proximity operation part, which can be operated by detecting a proximity, instead of the touch operation part 114. The proximity operation part is operated by detecting a motion of a hand, for example, by a proximity sensor. The operation part may detect a motion of the user by a camera, for example, to receive the operation performed by the user.

In the display screen 102 as one example shown in FIG. 1, the cover panel, the display 120, and the touch operation part 114 are overlapped in a front view of the display screen 102, and the user operates an object displayed on the display screen 102 by performing the touch operation on the object on the cover panel.

The optical sensor 103 serves as a brightness detector to detect a surrounding brightness. In one example shown in FIG. 1, the optical sensor 103 is located in a front surface of the mobile phone 100, however, its installation location is not limited to the above but may be disposed in another location as long as the optical sensor 103 detects the surrounding environment with high accuracy. The optical sensor 103 includes one to which a phototransistor, a photodiode, or the like is applied.

The speaker 104 has a function of outputting sound outside by a control signal from a processor 108, which will be described below. A location of the speaker 104 is not specifically limited, but the speaker 104 is located in a front surface, a side surface, or a rear surface of the mobile phone 100, for example. The speaker 104 can output, for example, a sound from an opposite party, a melody, and a ring tone.

The microphone 105 can convert the collected sound into a sound signal and output the sound signal to a sound encoder 117, which will be described below.

The button part 106 is a button-shaped hard key to receive an operation input from the user. The operation from the user received by the button part 106 is input to the processor 108 as the signal. In a case of FIG. 1, the button part 106 is pressed to be operated. The button part 106 includes, for example, a power-supply key, a volume key, and a home key.

The camera window 107 is located in the front surface or a back surface of the mobile phone 100. The camera window 107 comprises a transparent panel or lens and transmits a subject image to a camera module 116, which will be described below.

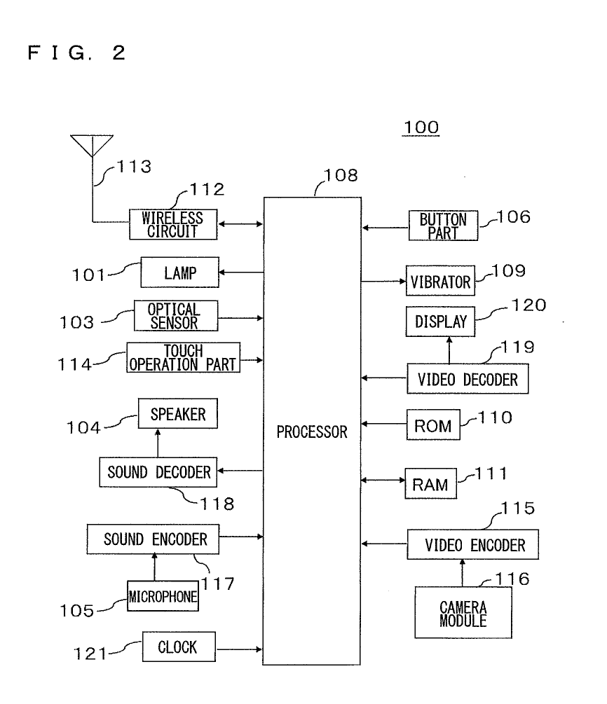

FIG. 2 illustrates a block configuration diagram of the mobile phone 100.

The mobile phone 100 includes at least one processor for providing control and processing capability to perform various functions as described in further detail below. In accordance with various embodiments, the at least one processor 108 may be implemented as a single integrated circuit (IC) or as multiple communicatively coupled IC's and/or discrete circuits. It is appreciated that the at least one processor 108 can be implemented in accordance with various known technologies.

In one embodiment, the processor 108 includes one or more circuits or units configurable to perform one or more data computing procedures or processes. For example, the processor 108 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

The processor 108 controls a software and a hardware in the mobile phone 100. For example, the processor 108 detects the input operation which the touch operation part 114, the button part 106, or the like receives from the user to perform various functions of the mobile phone 100. The processor 108 performs a program stored in the mobile phone 100 in cooperation with a ROM 110 or a RAM 111. The processor 108 includes a control CPU, for example.

A vibrator 109 can receive a control signal from the processor 108 to generate a mechanical vibration. The vibrator 109 is made up of a motor, for example, and informs the user of the incoming-call information, the received-mail information, the arrival of the alarm date and time, or the like with the mechanical vibration.

The ROM (Read Only Memory) 110 can store a program, data, or the like for performing various processing included in the mobile phone 100.

The RAM (Random Access Memory) 111 is accessible from the processor 108 and is used as a temporary storage region (also referred to as a buffer region) which is needed in order that the processor 108 performs the various processing. In addition, the

RAM 111 can store various data generated in the apparatus such as data used in a telephone, such as address book data and email data and image data and video data taken in a camera mode. The image stored in the RAM 111 includes a still image and a video. The video is made up of a plurality of frames, and each frame is made up of a still image. The still image includes an icon, a button, a picture, a thumbnail image and a text layout region. The text layout region is a region on which a text information is displayed. The video and the thumbnail image of the video, which will be described below, are associated with each other by an identification information of the video and then stored in the RAM 111.

A wireless circuit 112 can perform a demodulation processing and a decoding processing on a predetermined high frequency signal being input from an antenna 113 to convert the high frequency signal into a digital sound signal. The wireless circuit 112 can perform an encoding processing and a modulation processing on the digital sound signal being inputted from the processor 108 to convert the digital sound signal into a high frequency signal. Subsequently, the wireless circuit 112 can output the high frequency signal to the antenna 113.

The antenna 113 can receive a signal in predetermined frequency band and output the signal as the high frequency signal to the wireless circuit 112. The antenna 113 can output the high frequency signal being output from the wireless circuit 112 as the signal of the predetermined frequency band.

The camera module 116 has an image sensor such as a CCD. The camera module 116 can digitize an imaging signal being output from the image sensor and perform various corrections such as a gamma correction on the imaging signal to output the imaging signal to a video encoder 115. The video encoder 115 can performs an encoding processing on the imaging signal being output from the camera module 116 and output the imaging signal to the processor 108. The camera module 116 can take in a subject image through the camera window 107.

The sound encoder 117 can convert an analogue sound signal being output from the microphone 105 into a digital sound signal and perform an encoding processing on the digital sound signal to output the digital sound signal to the processor 108.

A video decoder 119 can convert an image information received from the processor 108 into an image signal to be displayed on the display 120 and output the image signal to the display 120. The display 120 can display an image in accordance with the image signal on a display surface thereof.

A sound decoder 118 can perform a decoding processing on a sound signal outputted from a CPU 100 and a sound signal of various notification sounds such as a ringtone and an alarm sound and further convert the sound signal into an analog sound signal to output the analog sound signal to the speaker 104.

A clock 121 can measure a time and output a signal in accordance with the measured time to the processor 108.

Operation Processing

An operation processing of the mobile phone 100 according to one embodiment is described below.

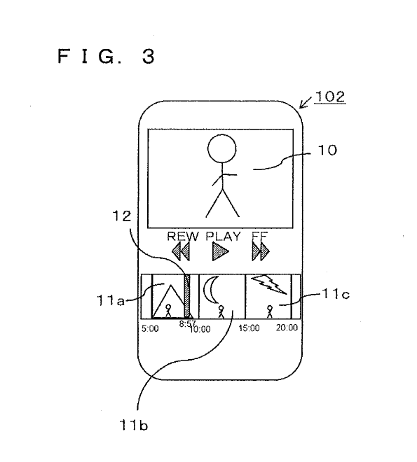

FIG. 3 illustrates an example of the display screen 102 of the mobile phone 100. FIG. 3 illustrates a video editing screen. Specifically, the display screen 102 shows thumbnails 11a to 11c indicating parts of one video divided every predetermined time (in FIG. 3, the video is divided every five minutes), a preview screen 10 of the video, and a progress bar 12 indicating a current progress of the video (in FIG. 3, the progress of the video displayed on the preview screen 10 is shown as eight minutes and fifty seven seconds). Displayed below the thumbnails 11a to 11c are times of the video (for example, 5:00 indicates five minutes and zero second).

The video may be taken with a camera included in the mobile phone 100 or may be downloaded from a site of Internet or the like.

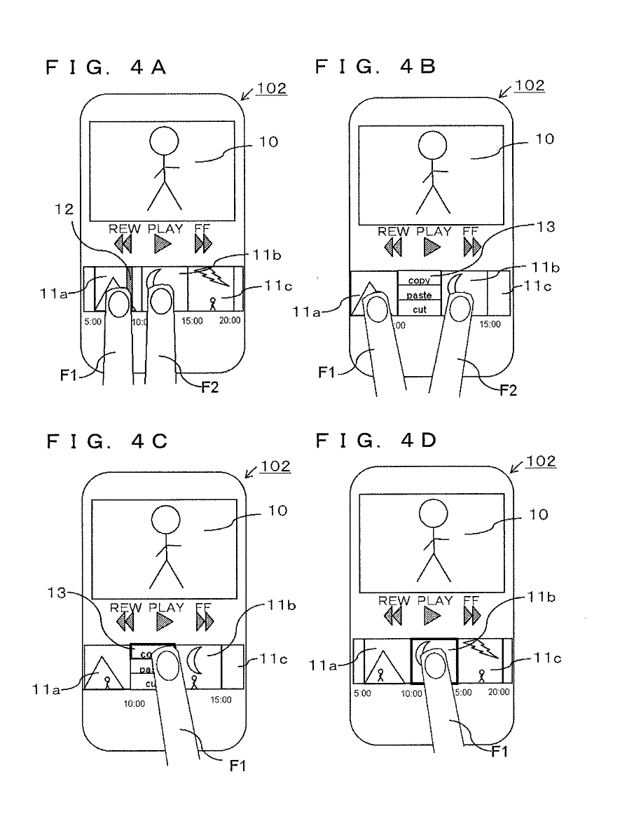

FIGS. 4A to 6B illustrate a sequence of a screen transition. In the display screen 102 in FIG. 4A, a finger F1 of the user touches the thumbnail 11a (object) and a finger F2 of the user touches the adjacent thumbnail 11b (object), thereby selecting the thumbnail 11a and the thumbnail 11b. When, in the state of FIG. 4A, the user spreads the fingers F1 and F2 while touching the thumbnails 11a and 11b as shown in FIG. 4B, the thumbnail 11a and the thumbnail 11b moving in accordance with the movement of the finger F1 and the finger F2 are displayed, and an operation menu 13 (object) is displayed between the thumbnails 11a and 11b after movement. In FIG. 4B, the operation menu 13 displays “copy”, “paste”, and “cut”, however, the present disclosure is not limited to the above configuration.

As shown in FIG. 4C, after the finger F1 and the finger F2 move away from the thumbnail 11a and thumbnail 11b, the finger F1 touches the operation menu 13 to select “copy” in the items of the operation menu 13. Subsequently, as shown in FIG. 4D, the finger F1 touches the thumbnail to select the thumbnail to be copied (the thumbnail 11b in one embodiment).

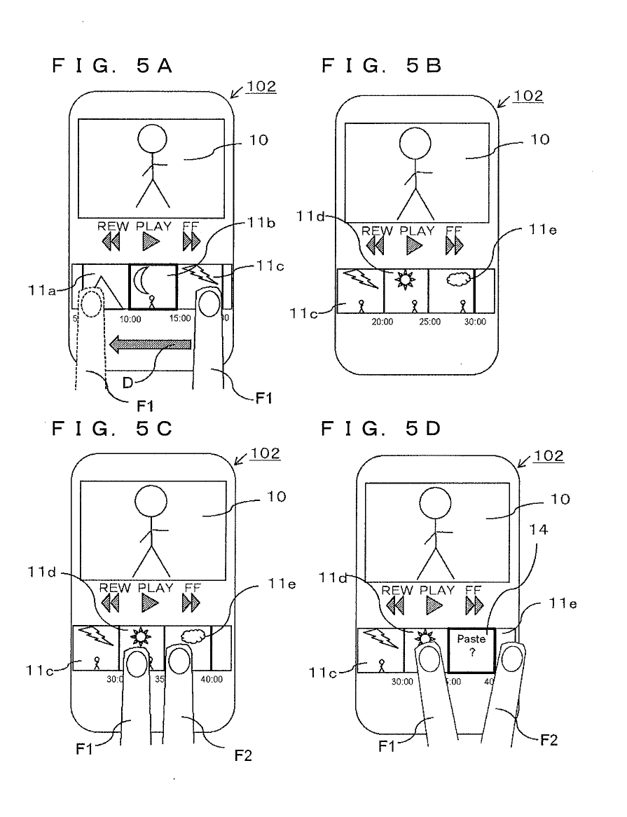

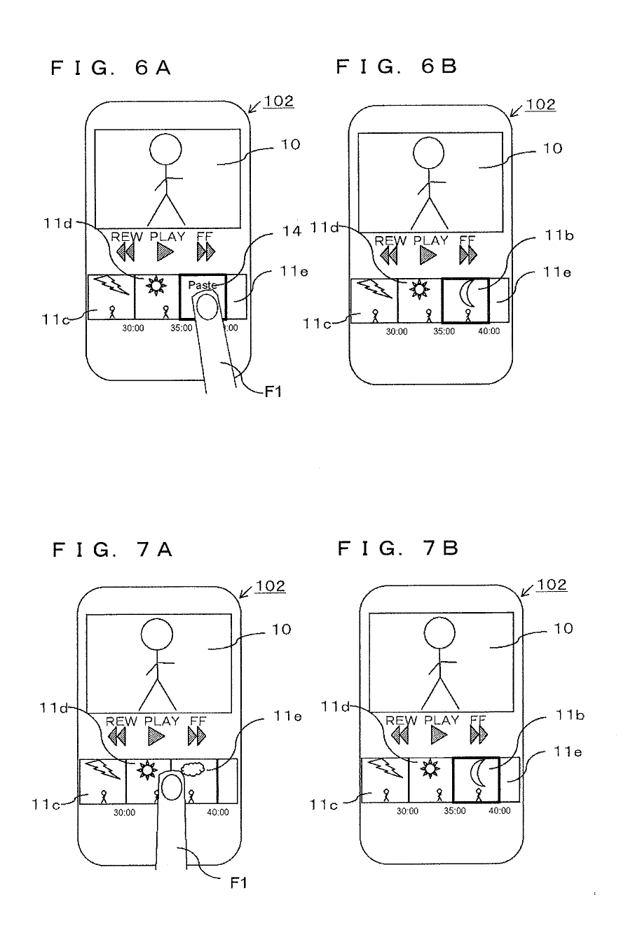

FIGS. 5A to 6B show the screen transition of the display screen 102 when the user selects a copy destination of the thumbnail to be copied and performs the copy.

After FIG. 4D, as shown in FIG. 5A, the user slides the finger F1 from a right side of the thumbnail 11b toward a left side (in a direction D in FIG. 5A). When the finger F1 is slid, thumbnails 11c to 11e located subsequently to the thumbnail 11b are displayed as shown in FIG. 5B.

As shown in FIG. 5C, the user selects a paste destination of the copied thumbnail 11b. In FIG. 5C, the user intends to paste the thumbnail 11b between the thumbnail 11d and the thumbnail 11e. When the user spreads the fingers F1 and F2 while touching the thumbnails 11d and 11e as shown in FIG. 5D, a display 14 shown as “Paste?” is displayed between the moved thumbnails 11d and 11e. When the user subsequently touches the display 14 showing “Paste?” with the finger F1 as shown in FIG. 6A, the thumbnail 11b is pasted between the thumbnail 11d and the thumbnail 11e as shown in FIG. 6B. The above operations enables a video part constituted by the thumbnail 11b to be located between a video part represented by the thumbnail 11d and a video part represented by the thumbnail 11e in the video.

As described above, the operations shown in FIGS. 4A to 6B move the two objects (in one embodiment, the objects correspond to the thumbnails relating to the plurality of parts forming the one video) to separate from each other, thereby enabling the other display (the operation menu 13 in one embodiment) to be displayed between the two object. Accordingly, the display, such as the operation menu, can be called up with a simple operation instead of providing a display region such as the operation menu separately in the normal display screen (in one embodiment, the normal display screen for editing the video). Especially, the above configuration is effective when the electronic apparatus has a small display screen (in particular, a mobile communication terminal device such as a mobile phone).

In FIG. 5C and FIG. 5D, when the user selects the paste destination of the thumbnail 11b to be copied, the user swipes the fingers F1 and F2 so as to separate the thumbnails 11d and 11e from each other to select the paste destination, however, the present disclosure is not limited to the above configuration. For example, the user may tap a boundary between the thumbnails 11d and 11e with the finger F1 as shown in FIG. 7A, thereby pasting the thumbnail to be pasted (the thumbnail 11b in one embodiment) between the thumbnail 11d and thumbnail 11e.

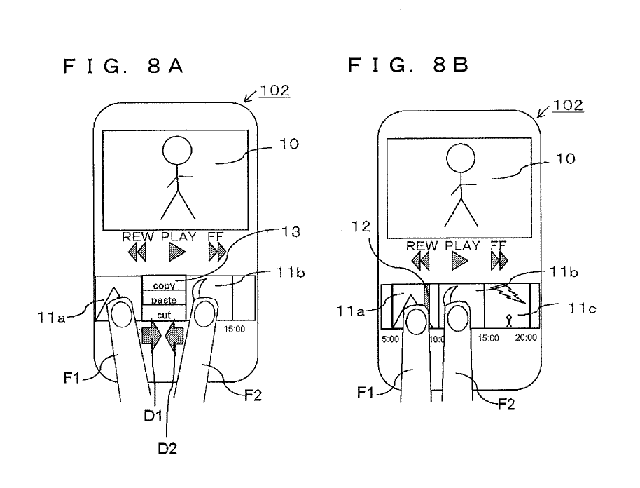

FIGS. 8A and 8B illustrate an example of an operation subsequent to FIG. 4A and FIG. 4B. When the user intends to cancel the display of the operation menu 13 after displaying the operation menu 13 on the display screen 102 as shown in FIG. 4B, the user moves the fingers F1 and F2 in a direction of bringing the thumbnails 11a and 11b closer to each other (a direction D1 and a direction D2 in FIG. 8A) while touching the thumbnails 11a and 11b with the fingers F1 and F2, then the display of the operation menu 13 disappears and the thumbnail 11a and the thumbnail 11b return to the initial display. The example of FIGS. 8A and 8B shows the operation of closing the fingers F1 and F2 while touching the thumbnails 11a and 11b with the fingers F1 and F2, the present disclosure is not limited to the above configuration. For example, the user may move the fingers F1 and F2 away from the display screen of FIG. 4B and then touch the thumbnails 11a and 11b again with the fingers F1 and F2 and then close the thumbnails 11a and 11b with the fingers F1 and F2 as shown in FIG. 8A.

The video editing in the mobile phone according to one embodiment is described above based on FIGS. 3 to 8B, however, the present disclosure is not limited to one example of FIGS. 3 to 8B.

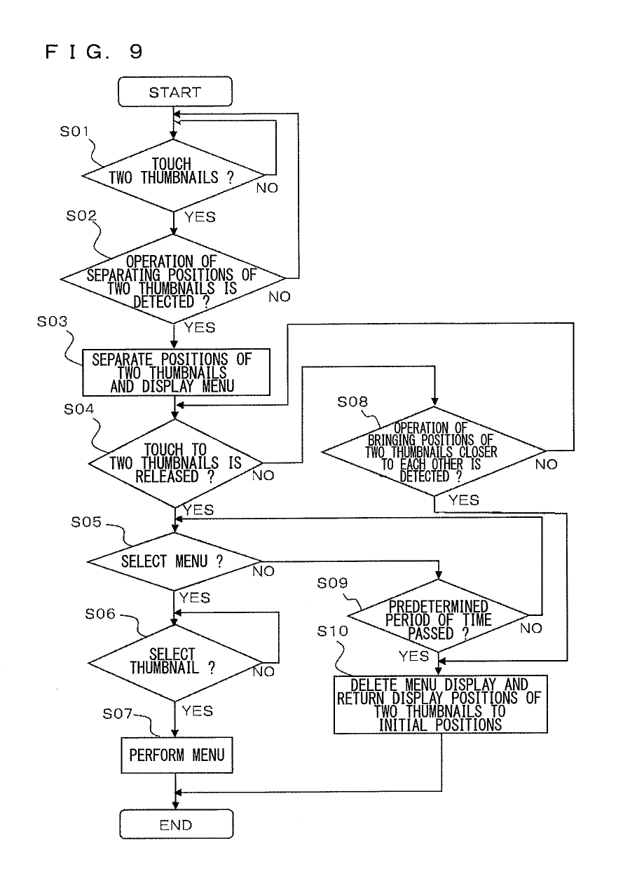

Next, a program for performing one embodiment is described using FIG. 9. one example is described based on FIGS. 3 to 8B.

In a step S01, it is detected whether the two thumbnails are touched. Specifically, as shown in FIG. 4A, it is detected whether the thumbnail 11a and the thumbnail 11b are touched. When the touch is not detected (the step S01: NO), the flow returns to the step S01 again. When the touch is detected (the step S01: YES), it is detected whether the operation of separating the positions of the two thumbnails is performed (a step S02). Specifically, it is detected that whether the touch positions of the thumbnails 11a and 11b are separated from each other subsequently to the state where the thumbnails 11a and 11b are touched with the finger, for example, as shown in FIG. 4B. When the operation of separating the two thumbnails is not detected (the step S02: NO), the flow returns to the step S01. When the operation of separating the two thumbnails is detected (the step S02: YES), the positions of the two thumbnails are separated and the operation menu is then displayed (a step S03). Specifically, in FIG. 4B, the thumbnail 11a and the thumbnail 11b move so that their display positions are separated from each other, and the operation menu 13 is then displayed between the thumbnail 11a and 11b after movement.

It is detected whether the touch to the two thumbnails is released, that is to say, whether the touch which has been detected is no longer detected (a step S04). When the tough to the two thumbnails is not released (the steps 04: NO), that is to say, when the touch to the two thumbnails is continued, a flow goes on to a step S08, which will be described below. When the touch to the two thumbnails is released (the step S04: YES), it is detected whether the selection operation is performed on the operation menu (a step S05). Specifically, it is detected whether the touch to any of the items (copy, paste, and cut) displayed in the operation menu 13 to select the item is detected as shown in FIG. 4C. When the selection operation is not performed on the menu (the step S05: NO), the flow goes on to a step S09, which will be described below. When the selection operation is performed on the menu (the step S05: YES), it is detected whether the thumbnail is selected (a step S06). Specifically, it is detected whether the thumbnail to be copied is selected in accordance with the “copy” selected in the operation menu 13 as shown in FIG. 4D. When the thumbnail is not selected (the step S06: NO), the flow returns to the step S06. When the thumbnail is selected (the step S06: YES), the menu is performed (a step S07). Specifically, the copied thumbnail 11b is pasted between the thumbnail 11d and the thumbnail 11e as shown in FIG. 6B, and then the flow is finished.

When the touch to the two thumbnails is not released in the step S04 (the step S04: NO), it is detected whether the operation of bringing the positions of the two thumbnails closer to each other is performed (the step S08). Specifically, as shown in FIG. 8A, it is detected whether the touch positions of the fingers or the like touching the thumbnails 11a and 11b, which are separately displayed with the operation menu 13 therebetween, has moved closer to each other (the step S08). When the operation of bringing the positions of the two thumbnails closer to each other is not pertained (the step S08: NO), the flow returns to the step S04. When the operation of bringing the positions of the two thumbnails closer to each other is performed (the step S08: YES), the display of the operation menu is deleted and then the display positions of the two thumbnails return to the initial positions (a step S10).

When the menu is not selected in the step S05 (the step S05: NO), it is detected whether a predetermined period of time has passed (the step S09). When the predetermined period of time has not passed (the step S09: NO), the flow returns to the step S05. When the predetermined period of time has passed (the step S09: YES), the display of the operation menu is deleted and then the display positions of the two thumbnails return to the initial positions (a step S10).

The touch operations on the thumbnails at a time of the video editing in the electronic apparatus (the mobile phone in one embodiment) are described in FIGS. 3 to 9, however, the present disclosure is not limited to the operations on the thumbnails at the time of the video editing. For example, when thumbnails of a plurality of different videos are displayed on the display screen, the two thumbnails are selected and then a operation is pertained for moving display positions of two thumbnails away from each other, so that a display (the operation menu illustrated in FIG. 4) different from the two thumbnails may be displayed.

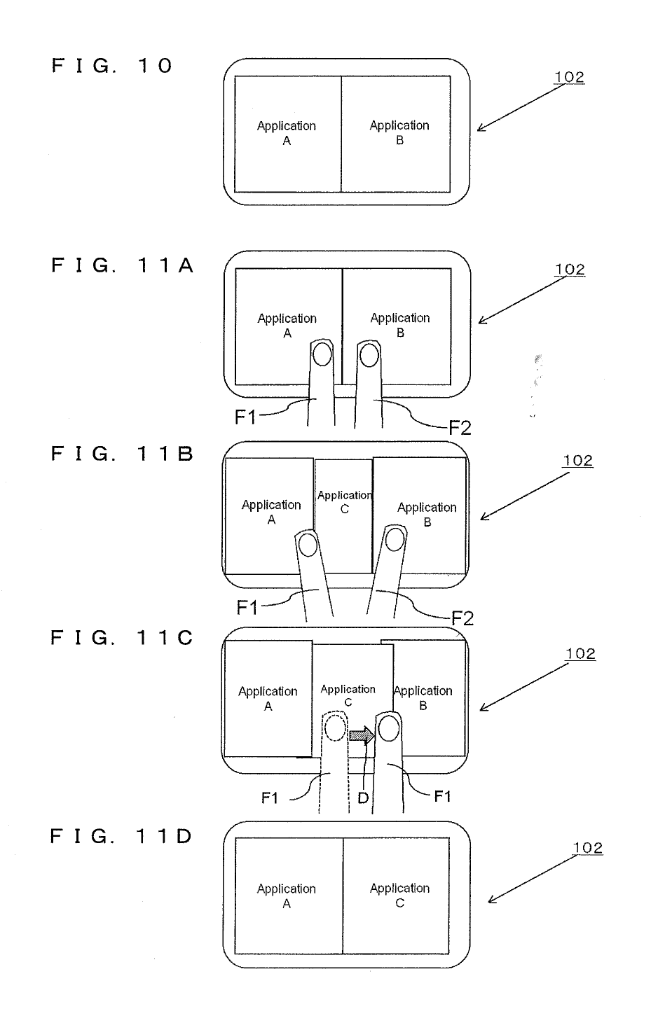

FIGS. 10 to 11D illustrate touch operations on two applications, both of which are active, as one embodiment different from that of FIGS. 3 to 9.

The two application are active in the display screen 102 of the mobile phone 100 in FIG. 10. One application is an application A, and other application is an application B. The above applications are displayed side by side on the display screen 102. The mobile phone 100 is longitudinally displayed in FIGS. 3 to 8B and laterally displayed in FIGS. 10 to 11D, so that either direction may be adopted as the display direction.

As shown in FIG. 11A, in the display screen 102 on which the application A and the application B are displayed, the finger F1 touches the application A and the finger F2 touches the application B adjacent to application A. When the user spreads the fingers F1 and F2 while touching the application A and the application B as shown in FIG. 11A and 11B, the application A and the application B moving in accordance with the movement of the finger F1 and the finger F2 are displayed. Subsequently, at least part of an application C is displayed between the application A and the application B. The application C indicates an application which is not displayed on the display screen 102 of FIG. 11A but is active. FIG. 11B illustrates the application A and the application B separated from each other to a certain extent. At least the part of the application C may also be displayed in a state where the application A and the application B are not so separated from each other as they are shown in FIG. 11B. Such a display enables the user to confirm the presence of the application C which is not displayed but active only with a simple operation of spreading the fingers F1 and F2 a little while touching the application A and the application B. After the user confirms the application C, the operation of FIGS. 8A and 8B described in the above specific example, for example, may be applied, that is, the fingers F1 and F2 touch and move the applications A and B in the direction of bringing the applications A and B closer to each other so that the display of the application C is deleted and then, as shown in FIG. 10, the display positions of the applications A and B return to the initial positions.

In FIG. 11B, the application C is displayed so as to be located behind the application A and the application B, however, the display of the application C is not limited to the above configuration.

FIG. 11C illustrates that after FIG. 11B, which shows that the user spreads fingers F1 and F2 while touching the applications A and B, the user moves the fingers F1 and F2 away from the display screen 102 and then intends to display the application C, which is displayed between the applications A and B, instead of the application B. Specifically, the user touches the application C with the finger F1 and then moves the finger from left to right as shown in FIG. 11C (a direction D) to locate the finger F1 on the application B. Accordingly, the display of the application C is moved to be located over the application B.

As shown in FIG. 11D, the operation in FIGS. 11A to 11C enables the display on a region in a right side of the display screen 102 to be changed from the application B to the application C. In FIG. 11D, the application B which is no longer displayed is active.

One example of FIGS. 10 and 11A to 11D shows the application display, which is active and displayed, as the first object and the second object and the application display, which is not displayed but active, as the third object.

Although the present disclosure is described above using drawings, the present disclosure is not limited to examples illustrated in drawings. Although in FIGS. 3 to 11D, the first object and the second object are adjacent to each other without a gap in the first state shown in FIG. 3 and FIG. 10, the gap may be located between the first object and the second object, or other object may be located between the first object and the second object in the first state.

Although examples illustrated in drawings show the display of the thumbnail and application as the object (including the first object, the second object, and the third object), the present disclosure is not limited to the above. For example, the object may include an icon (an icon indicative of an application or an icon indicative of notification), a character, and a soft key in a soft keyboard.

Although examples illustrated in drawings show the operation through the touch operation, the present disclosure is not limited to the above. For example, the object may be operated not by touching but by getting close to the display screen 102, and the object may be operated even when the user is 1 m or more away from the electronic apparatus, for example.

The operation may be performed by the user not only with the finger but an operation by visual line, voice, or a gesture or an operation using an operation tool such as a stylus is also applicable.

1. An electronic apparatus comprising:
a display screen capable of displaying a first object and a second object; and
at least one processor causing the display screen to display the first object and the second object,
wherein in a first state where the first object and the second object are displayed on the display screen, when a second operation of separating positions of the first object and second object from each other is detected after a first operation of selecting the first object and the second object is detected, the processor changes a display of the display screen to a second state where the first object and the second object, which are more distant from each other than those in the first state, are displayed with a third object displayed therebetween.

2. The electronic apparatus according to claim 1, wherein the first operation and the second operation are touch operations.

3. The electronic apparatus according to claim 1, wherein the first object and the second object are thumbnails relating to a video, and the third object is an operation menu relating to the video.

4. The electronic apparatus according to claim 1, wherein the first object and the second object are screens of an application being active, and
the third object is a screen of an application which is active, the screen not displayed in the first state.

5. The electronic apparatus according to claim 1, wherein when an operation of returning a position of the first object and a position of the second object to the first state is performed in the second state, the display of the third object is deleted.

6. A non-transitory computer-readable recording medium that stores a control program so as to cause an electronic apparatus including a display screen to perform a step of:
in a first state where the first object and the second object are displayed on the display screen, when a second operation of separating positions of the first object and second object from each other is detected after a first operation of selecting a first object and a second object is detected, changing a display of the display screen to a second state where the first object and the second object, which are more distant from each other than those in the first state, are displayed with a third object displayed therebetween.

7. A display control method of an electronic apparatus including a display screen, the method comprising a step of:
in a first state where the first object and the second object are displayed on the display screen, when a second operation of separating positions of the first object and second object from each other is detected after a first operation of selecting a first object and a second object is detected, changing a display of the display screen to a second state where the first object and the second object, which are more distant from each other than those in the first state, are displayed with a third object displayed therebetween.
